(19) United States
(12) Patent Application Publication
(10) Pub. No.: US 2024/0383158 A1
(43) Pub. Date: Nov. 21, 2024

(54) FINGER-GRIPPER ASSEMBLY AND FINGER-GRIPPER ASSEMBLY SYSTEM INCLUDING THE SAME

(71) Applicants: Hyundai Motor Company, Seoul (KR); Kia Corporation, Seoul (KR)

(72) Inventors: Beom Su Kim, Yongin-Si (KR); Hyun Seop Lim, Anyang-Si (KR); Ju Young Yoon, Suwon-Si (KR); Kyu Jung Kim, Seoul (KR); Min Woong Jeung, Seoul (KR); Hyo Joong Kim, Seongnam-Si (KR); Seong Taek Hwang, Suwon-Si (KR); Ho Jun Kim, Gunpo-Si (KR); Dong Jin Hyun, Suwon-Si (KR); Dong Hyun Lee, Ansan-Si (KR)

(21) Appl. No.: 18/509,827

(22) Filed: Nov. 15, 2023

(30) Foreign Application Priority Data
May 17, 2023 (KR) 10-2023-0063863

(51) Int. Cl. B25J 15/10

(52) U.S. Cl. CPC B25J 15/10

(57) ABSTRACT

The present disclosure relates to a finger-gripper assembly and a finger-gripper assembly system including the same. The finger-gripper assembly includes a finger and a gripper to which the finger is coupled so as to be removable. The gripper includes an arm, an extender coupled to a lower end of the arm so as to be rotatable about a first axis, wherein the extender extends, from the arm along a second axis that extends in an extension direction and intersects with the first axis, and a connector coupled to a lower side of the extender so as to be movable along the second axis, wherein the connector is connectable to the finger.

### CROSS-REFERENCE TO RELATED APPLICATION

This application claims the benefit of priority to Korean Patent Application No. 10-2023-0063863, filed in the Korean Intellectual Property Office on May 17, 2023, the entire contents of which are incorporated herein by reference.

### TECHNICAL FIELD

The present disclosure relates to a finger-gripper assembly and a finger-gripper assembly system including the same.

### BACKGROUND

Recently, various robot arms have been developed to increase the grip-based usability of robots. Typical examples may be a tool changer and an adaptive gripper.

The tool changer is an apparatus that is located on an end effector of a robot and that enables replacement of the entire tool suitable for an object to be worked. Various tools may be mounted on the tool changer, and one of them may be a gripper.

On the premise that the entire tool is replaced, the tool changer has to be provided with various tools suitable for various objects to be gripped or worked. Therefore, there is a problem in that cost is increased and a space or apparatus for storing the various tools is required.

The adaptive gripper is a gripper capable of increasing gripping effect based on a flexible gripping mechanism, a exclusive of tool replacement. The adaptive gripper has an advantage of reducing cost and time due to tool replacement, but has a problem in that the range of work is limited depending on the size and performance of the gripper.

### SUMMARY

The present disclosure has been made to solve the above-mentioned problems occurring in the prior art while advantages achieved by the prior art are maintained intact.

An aspect of the present disclosure provides a finger-gripper assembly capable of replacing a finger connected to a gripper and a finger-gripper assembly system including the same.

The technical problems to be solved by the present disclosure are not limited to the aforementioned problems, and any other technical problems not mentioned herein will be clearly understood from the following description by those skilled in the art to which the present disclosure pertains.

According to one or more example embodiments of the present disclosure, a finger-gripper assembly may include: a finger, and a gripper to which the finger is coupled so as to be removable. The gripper may include: an arm; an extender coupled to a lower end of the arm so as to be rotatable about a first axis, wherein the extender extends, from the arm, along a second axis that extends in an extension direction and intersects with the first axis; and a connector coupled to a lower side of the extender so as to be movable along the second axis, wherein the connector is connectable to the finger.

The finger may include: a finger body having a mounting hole, wherein the mounting hole is formed on an upper side of the finger body and open upward such that a lower side of the connector is inserted into the mounting hole; and a latch connected with the connector to obstruct separation of the connector from the mounting hole, after the connector is inserted into the mounting hole.

The latch may include: an overlapping region configured to overlap the mounting hole when viewed from above; and a protrusion configured to protrude out of the finger body when viewed from above.

The latch may be rotatable about a rotational axis located between the overlapping region and the protrusion and extending in a direction of the first axis, after the protrusion is pressed toward the finger body.

The finger may further include a cover, in which a portion of the mounting hole is formed, the cover being coupled with the finger body and disposed on an upper side of the latch. The latch may be covered from an upper side by the cover after the protrusion is pressed toward the finger body.

The connector may include a coupling groove, into which the overlapping region is inserted. Movement of the connector in the direction of the first axis may be restricted after the overlapping region is inserted into the coupling groove.

The finger may further include a support configured to elastically push the protrusion away from the finger body.

The latch may include a pair of latch arms spaced apart from each other with the mounting hole therebetween. The support may be disposed between protrusions of the pair of latch arms.

The finger may further include a stop that is brought into contact with an end portion of the overlapping region to obstruct movement of the overlapping region toward the finger body.

The finger may further include a cover, in which a portion of the mounting hole is formed, the cover being coupled with the finger body and disposed on an upper side of the support.

The protrusion may include an inclined portion in which the latch curves toward the finger body.

The overlapping region may include: a first overlapping portion disposed on a side of the connector in the extension direction to support a support surface located on the side of the connector in the extension direction; and a second overlapping portion inserted into the coupling groove to obstruct movement of the connector in the direction of the first axis.

The extender may include a plurality of extenders, and the finger comprises a plurality of fingers. A quantity of the connector corresponds to a quantity of the plurality of extenders, and a quantity the plurality of fingers corresponds to the quantity of the plurality of extenders.

According to one or more example embodiments of the present disclosure, a finger-gripper assembly system may include: a finger; a gripper to which the finger is coupled so as to be removable; and a station configured to store a removed finger. The gripper may include: an extender configured to extend in an extension direction intersecting a first axis; and a connector coupled to a lower side of the extender so as to be movable in the extension direction. The connector may be coupled to the finger. The station may include: a station body having a main hole; and a finger insertion groove into which an upper side of the finger is inserted. The finger insertion groove may extend from the main hole in the extension direction.

The finger may include: a finger body having a mounting hole, wherein the mounting hole is formed on an upper side of the finger body and open upward such that a lower side of the connector is inserted into the mounting hole; and a latch connected with the connector to obstruct separation of the connector from the mounting hole, after the connector is inserted into the mounting hole. A width of the finger insertion groove may correspond to a width of a portion of the finger body inserted into the finger insertion groove.

The latch may include a protrusion configured to protrude out of the finger body. The protrusion may be pressed toward the finger body by a region comprising the finger insertion groove, after the finger is inserted into the finger insertion groove.

The finger insertion groove may have an opening toward the finger body, when the finger is disposed in the finger insertion groove.

The finger may further include a first magnet disposed on an end portion of the finger body in the extension direction. The station may further include a second magnet configured to generate an attractive force with respect to the first magnet. The second magnet may be disposed, in the extension direction, on an end portion of a region comprising the finger insertion groove.

The extender may include a plurality of extenders. The connector may include a plurality of connectors. The finger may include a plurality of fingers. The finger insertion groove may include a plurality of finger insertion grooves. A quantity of the plurality of extenders may correspond to a quantity of the plurality of fingers. A quantity of the plurality of connectors may correspond to the quantity of the plurality of fingers. A quantity of the plurality of finger insertion grooves may correspond to the quantity of the plurality of fingers.

### BRIEF DESCRIPTION OF THE DRAWINGS

The above and other objects, features and advantages of the present disclosure will be more apparent from the following detailed description taken in conjunction with the accompanying drawings:

FIG. 1 is a perspective view illustrating a finger-gripper assembly system according to an embodiment of the present disclosure;

FIG. 2 is a view illustrating an upper side of a finger;

FIG. 3 is an exploded perspective view of the finger illustrated in FIG. 2;

FIG. 4 is a view of the finger of FIG. 3 as viewed in a different direction;

FIG. 5 is a perspective view illustrating a connecting member of a gripper;

FIG. 6 is a view illustrating a state in which the finger and the connecting member are connected;

FIG. 7 is a view of the finger as viewed from above;

FIG. 8 is a view illustrating a state in which a cover member is removed in FIG. 7;

FIG. 9 is a view illustrating a state in which a protruding region is pressed toward the inside of a finger body in FIG. 8;

FIG. 10 is a view illustrating a state in which the cover member is removed in FIG. 9;

FIG. 11 is a view illustrating a station;

FIG. 12 is a schematic view when a finger coupling groove is viewed in an extension direction;

FIGS. 13 to 16 are views illustrating a process in which the finger and the gripper are manually coupled to each other without using the station; and

FIGS. 17 to 20 are views illustrating a process in which the finger and the gripper are coupled to each other using the station.

### DETAILED DESCRIPTION

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of well-known features or functions will be ruled out in order not to unnecessarily obscure the gist of the present disclosure.

A finger-gripper assembly according to an embodiment of the present disclosure may be a component capable of mimicking movement of a person's hand for gripping an object. In addition, a finger-gripper assembly system according to an embodiment of the present disclosure may refer to both a station 300 where a finger 100 is stored and the finger-gripper assembly.

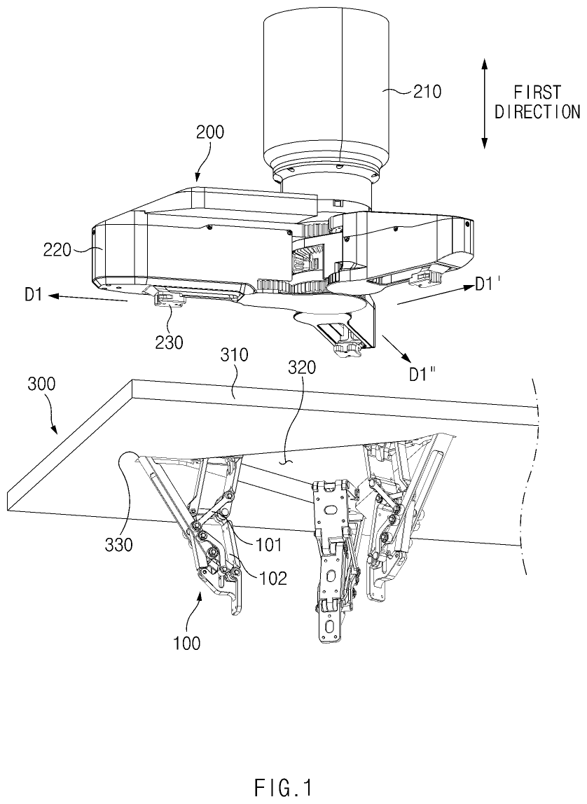

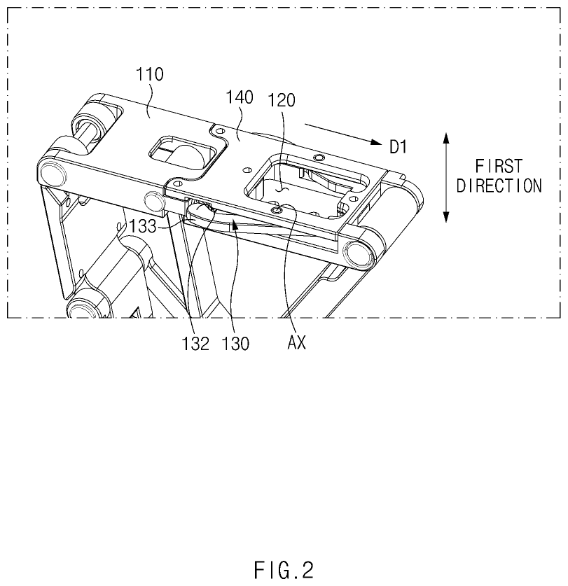

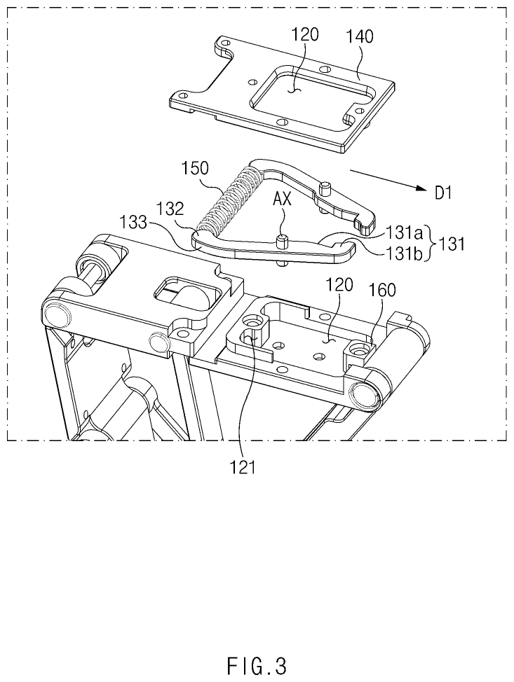

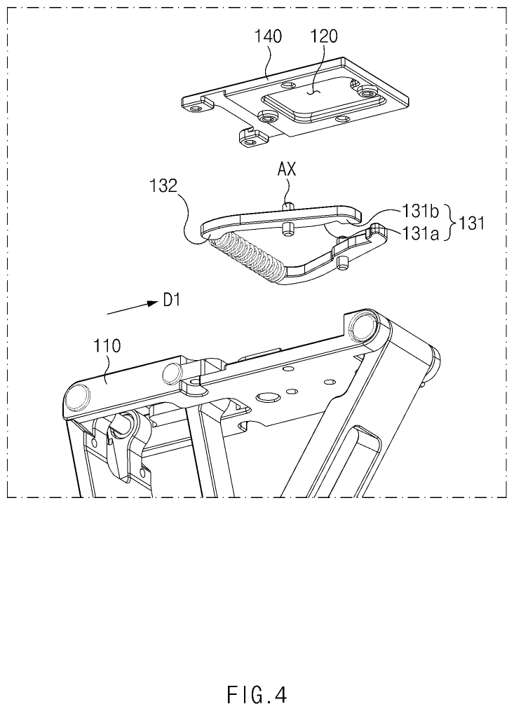

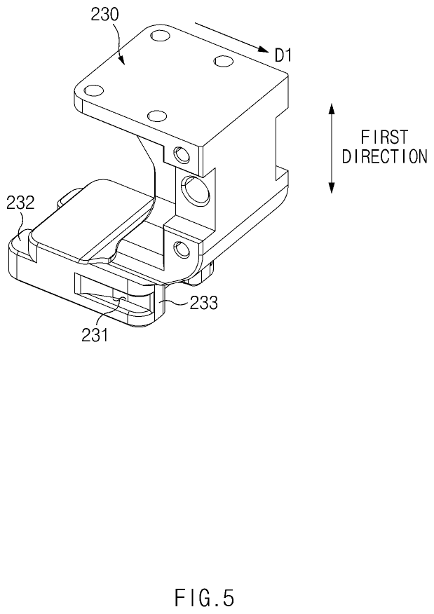

FIG. 1 is a perspective view illustrating the finger-gripper assembly system according to an embodiment of the present disclosure. FIG. 2 is a view illustrating an upper side of the finger. FIG. 3 is an exploded perspective view of the finger illustrated in FIG. 2. FIG. 4 is a view of the finger of FIG. 3 as viewed in a different direction. FIG. 5 is a perspective view illustrating a connecting member of a gripper.

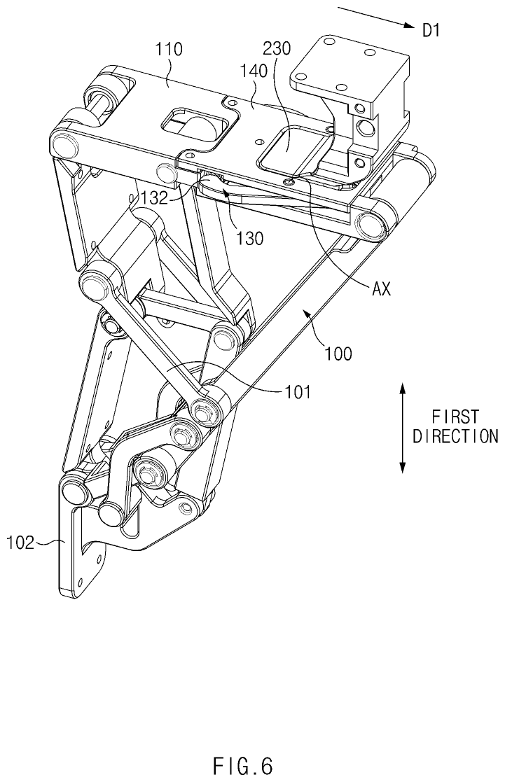

FIG. 6 is a view illustrating a state in which the finger and the connecting member are connected.

In the specification of the present disclosure, several directions including a first direction (e.g., a vertical direction, a horizontal direction, an up/down direction, etc.)

and an extension direction D1 may be relative directions used to explain the shape and operation of the finger-gripper assembly and may vary depending on the direction in which the finger-gripper assembly is disposed.

The finger-gripper assembly according to an embodiment of the present disclosure may include the finger 100 and the gripper 200. The finger 100 may be coupled to the gripper 200 so as to be removable. The finger 100 may have various examples. For example, the finger 100 may be a component for mimicking movement of the person's finger. The finger 100, when pressed, may be deformed and may be in a state capable of gripping the object. For example, the finger 100 may have a plurality of links 101 for operation and a separate pad part 102 for gripping the object.

However, the shape of the finger 100 illustrated in the drawings is illustrative, and the finger 100 may have various modified examples depending on situations in which a user wants to use the finger 100.

The gripper 200 may be a component to which the finger 100 is coupled. A plurality of fingers 100 may be coupled to the gripper 200. The gripper 200 may be a component for moving the fingers 100 to desired positions.

The gripper 200 may include an arm member 210 (e.g., an arm), an extension member 220 (e.g., an extender), and a connecting member 230 (e.g., a connector). The arm member 210 may have a shape extending in the first direction. The extension member 220 may extend from the arm member 210 in the extension direction D1. The extension direction may be a direction crossing the first direction. A plurality of extension members 220 may be formed.

When the plurality of extension members 220 are formed, the extension directions D1 may differ from one another depending on the positions of the extension members. For example, when an extension member 220 extending leftward exists, the extension direction D1 may be the left direction. In another example, when an extension member 220 extending rightward exists, the extension direction D1 may be the right direction. That is, the extension direction is not fixed in any one direction, but is determined depending on the direction in which the extension member 220 extends. If there are more than one extension members 220, then each extension member 220 may have its own corresponding extension direction, which, for clarity of illustration, may also be referred to as extension direction D1′, an extension direction D1″, an extension direction D1′″, etc., which may be different from and/or same as each other. However, these extension directions may be collectively referred to as extension direction(s) D1.

The extension members 220 may be coupled to a lower end of the arm member 210 so as to be rotatable about an axis extending in the first direction. For example, the extension members 220 and the arm member 210 may be coupled in such a manner that a gear formed on the arm member 210 is engaged with gears formed on the extension members 220. However, this is merely illustrative, and no special limitation applies to the coupling of the arm member 210 and the extension members 220 as long as the arm member 210 and the extension members 220 are connected so as to be rotatable relative to each other.

The extension members 220 are rotatable about the arm member 210. In addition, the extension members 220 are also rotatable about a point where the extension members 220 are connected with the arm member 210. In this case, one motor for rotating the extension may members 220 be provided. Alternatively, a plurality of motors for rotating the extension members 220 may be provided.

The connecting member 230 may be coupled to a lower side of each of the extension members 220 so as to be movable in the extension direction D1. The connecting member 230 may be connected with the finger 100. The connecting member 230 may refer to a member that connects the gripper 200 and the finger 100. The connecting member 230 may include the same number of connecting members as the extension members 220, and the finger 100 may include the same number of fingers as the extension members 220.

According to the present disclosure, only the finger 100 may be replaced instead of replacement of the gripper 200 and the finger assembly coupled thereto. Accordingly, the apparatus may be simplified, and a storage space for the apparatus may be reduced. Hereinafter, a configuration for coupling and separating the gripper 200 and the finger 100 will be described in more detail.

The finger 100 may include a finger body 110, a mounting hole 120, and a separation preventing member 130. The finger body 110 may be a component including the plurality of links 101 and the pad part 102.

The mounting hole 120 may be formed on an upper side of the finger body 110 and may be open upward such that a lower side of the connecting member 230 is inserted into the mounting hole 120. The mounting hole 120 may be a component for accommodating the connecting member 230. The mounting hole 120 may partially allow movement of the connecting member 230 in the extension direction D1 (e.g., along an axis that extends in the extension direction D1) and the direction opposite to the extension direction D1 (e.g., along the axis that extends in the extension direction D1). To this end, the mounting hole 120 may include a portion having a length longer than the length of a lower end portion of the connecting member 230 in the extension direction D1.

The connecting member 230 may include a protrusion 232 protruding in the direction opposite to the extension direction D1, and the mounting hole 120 may have a receiving region 121 that accommodates the protrusion 232 when the protrusion 232 moves in the direction opposite to the extension direction D1. When the protrusion 232 is accommodated in the receiving region 121, movement of the protrusion 232 in the extension direction D1 may be allowed, but movement of the protrusion 232 in the first direction may be obstructed. This may mean that a traffic line along which the connecting member 230 is inserted into the mounting hole 120 is similar to “L”.

When the connecting member 230 is inserted into the mounting hole 120, the separation preventing member 130 may be connected with the connecting member 230 and may obstruct separation of the connecting member 230 from the mounting hole 120.

The separation preventing member 130 (e.g., a latch) may include an overlapping region 131 and a protruding region 132. The overlapping region 131 may overlap the mounting hole 120 when viewed from above. The overlapping region 131 may be a portion for obstructing separation of the connecting member 230.

The connecting member 230 may include a coupling groove 231. The coupling groove 231 may be a groove into which the overlapping region 131 is inserted. When the overlapping region 131 is inserted into the coupling groove 231, movement of the connecting member 230 in the first direction may be restricted. To this end, the coupling groove 231 may have a shape that is open toward the outside of the finger body 110. For example, the direction toward the outside of the finger body 110 may be a direction perpendicular to the extension direction D1 and the first direction.

The overlapping region 131 may include a first overlapping portion 131a and a second overlapping portion 131b. The first overlapping portion 131a may be disposed on a side of the connecting member 230 in the extension direction D1 to support a support surface 233 located on the side of the connecting member 230 in the extension direction D1. The first overlapping portion 131a may be a component for obstructing movement of the connecting member 230 in the extension direction D1 and the direction opposite to the extension direction D1. The second overlapping portion 131b may be a portion that is inserted into the coupling groove 231 and that obstructs movement of the connecting member 230 in the first direction.

The protruding region 132 may protrude outward from the finger body 110 when viewed from above. The protruding region 132 may be a portion that, when pressed, moves the separation preventing member 130 (e.g., a latch) to release the connection of the overlapping region 131 and the connecting member 230.

The separation preventing member 130 (e.g., a latch) may rotate about a rotational axis AX. The rotational axis AX may extend in the first direction. The rotational axis AX may be located between the overlapping region 131 and the protruding region 132 when the protruding region 132 is pressed toward the inside of the finger body 110 (e.g., toward the finger body 110). This may mean that when the protruding region 121 moves toward the inside of the finger body 110, the overlapping region 121 moves toward the outside of the finger body 110 (e.g., away from the finger body 110) and, in contrast, when the protruding region 132 moves toward the outside of the finger body 110, the overlapping region 131 moves toward the inside of the finger body 110.

The protruding region 132 may include an inclined portion 133. The inclined portion 133 may be a portion in which the degree of protrusion in the direction toward the outside of the finger body 110 decreases in the extension direction D1. For example, the inclined portion 133 may be a portion in which the separation member 130 (e.g., a latch or a latch arm) curves toward the finger body 110. In relation to the station 300 to be described below, the inclined portion 133 may be a component that allows the station 300 to smoothly press the protruding region 132 inward. Details will be described in operation of the finger-gripper assembly system according to an embodiment of the present disclosure.

For example, a pair of separation preventing members 130 (e.g., a latch) may be spaced apart from each other with the mounting hole 120 therebetween. However, it is also possible that one separation preventing member 130 (e.g., a latch) is formed.

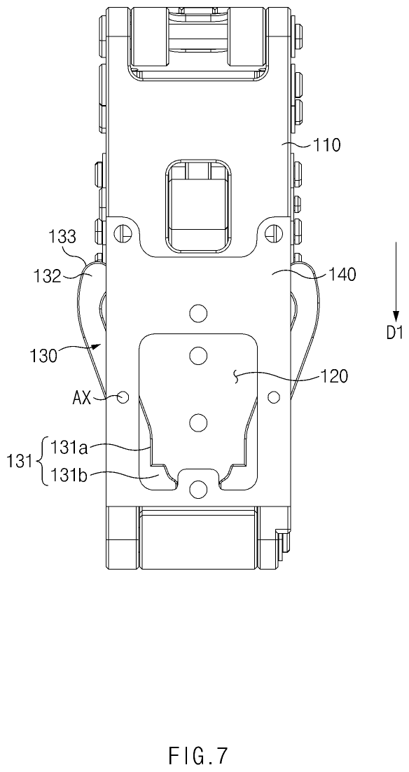

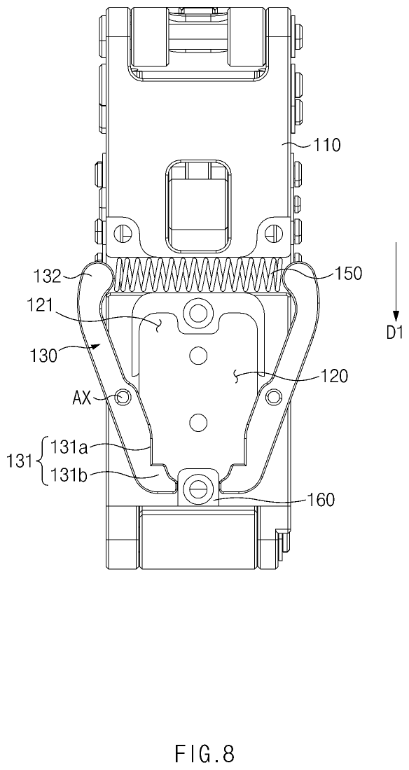

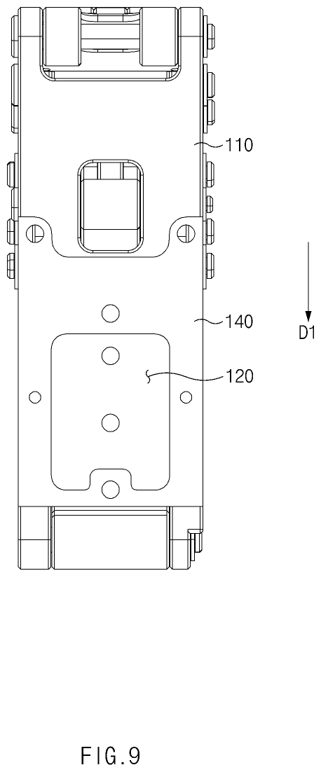

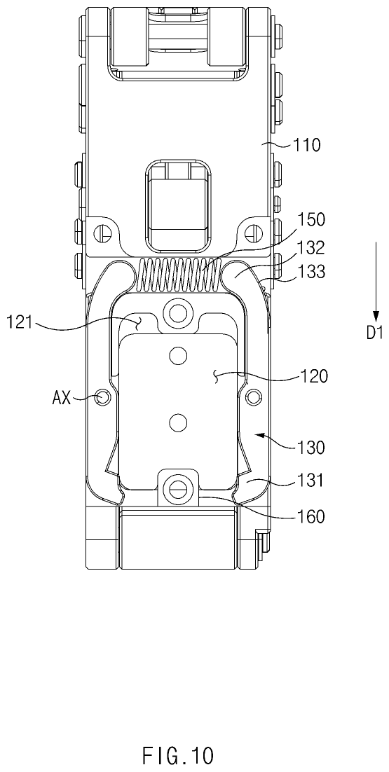

FIG. 7 is a view of the finger as viewed from above. FIG. 8 is a view illustrating a state in which a cover member is removed in FIG. 7. FIG. 9 is a view illustrating a state in which the protruding region is pressed toward the inside of the finger body in FIG. 8. FIG. 10 is a view illustrating a state in which the cover member is removed in FIG. 9.

The finger 100 may further include the cover member 140. The cover member 140 may be coupled with the finger body 110 and may be disposed on an upper side of the separation preventing member 130. A portion of the mounting hole 120 may be formed in the cover member 140. This may mean that the mounting hole 120 is defined based on when the cover member 140 is coupled to the finger body 110.

The separation preventing member 130 may be covered from the upper side by the cover member 140 when the protruding region 132 is pressed toward the inside of the finger body 110. This means that the protruding region 132, when pressed toward the inside of the finger body 110, is disposed such that a portion protruding outside the cover member 140 does not exist as viewed from above. In this state, the protruding region 132 may be moved outside the finger body 110, and the second overlapping portion 131b may be separated from the coupling groove 231. Furthermore, the first overlapping portion 131a may not be brought into contact with the support surface 233. Accordingly, movement of the connecting member 230 in the first direction, the extension direction D1, and the direction opposite to the extension direction D1 may be allowed.

The finger 100 may further include a support member 150. The support member 150 may elastically support (e.g., push) the protruding region 132 toward the outside of the finger body 110 (e.g., away from the finger body 110). The support member 150 may be disposed between the protruding regions 132 of the pair of separation preventing members 130 (e.g., latch arms). The support member 150 may be a coil spring. The cover member 140 may be disposed on an upper side of the support member 150 and may cover the support member 150.

The finger 100 may further include an obstruction member 160 (e.g., a stop). The obstruction member 160 may be brought into contact with an end portion of the overlapping region 131 and may obstruct movement of the overlapping region 131 toward the inside of the finger body 110. Because the protruding region 132 is elastically supported toward the outside by the support member 150, the overlapping region 131 is forced to move toward the inside. Accordingly, the obstruction member 160 may restrict inward movement of the overlapping region 131 beyond a certain range.

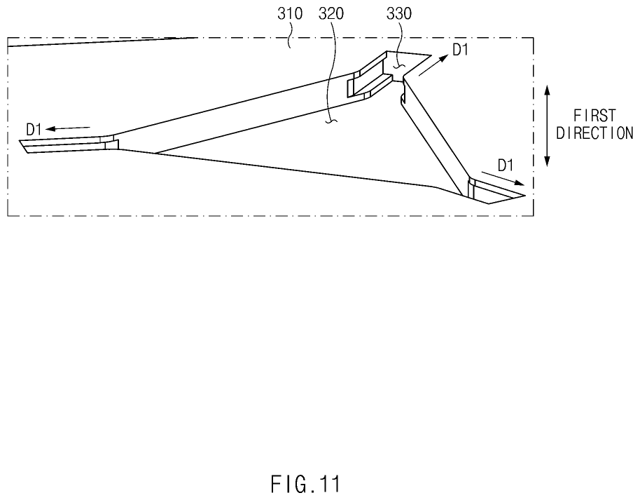

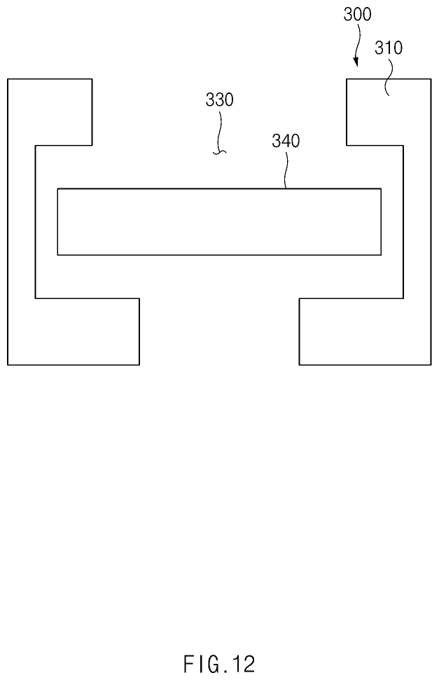

Hereinafter, the station 300 in which the finger 100 of the finger-gripper assembly is accommodated will be described in detail with reference to FIGS. 1, 11, and 12. FIG. 11 is a view illustrating the station 300. FIG. 12 is a schematic view when the coupling groove 231 is viewed in the extension direction D1.

The station 300 may include a station body 310, a main hole 320, and a finger insertion groove 330. The main hole 320 may be formed in the station body 310. The finger insertion groove 330 may extend from the main hole 320 in the extension direction D1 and may be provided such that an upper side of the finger 100 is inserted into the finger insertion groove 330. The finger insertion groove 330 may include the same number of finger insertion grooves as the extension members 220.

The finger insertion groove 330 may have a shape that is open toward the inside of the finger body 110 based on when the finger 100 is disposed in the finger insertion groove 330. In this case, an upper portion and a lower portion of a region of the station 300 that protrude toward the inside of the finger body 110 to define the finger insertion groove 330 may have different lengths.

The width of the finger insertion groove 330 may correspond to the width of a portion of the finger body 110 that is inserted into the finger insertion groove 330. For example, the width of the finger insertion groove 330 may correspond to the width of the cover member 140. As the width of the finger insertion groove 330 corresponds to the width of the portion inserted into the finger insertion groove 330, the inclined portion 133 may be pressed by the region defining the finger insertion groove 330 in a process in which the finger 100 is inserted into the finger insertion groove 330 in the extension direction D1.

This may mean that the pressing of the inclined portion 133 is simultaneously performed in the process in which the finger 100 is inserted into the finger insertion groove 330. In this process, the protruding region 132 may be moved by being pressed toward the inside of the finger body 110.

The finger 100 may include a first magnetic member (not illustrated) (e.g., a magnet). The first magnetic member (not illustrated) may be disposed on an end portion of the finger body 110 in the extension direction D1. The station 300 may further include a second magnetic member 340 (e.g., a magnet). The second magnetic member 340 may be disposed on an end portion of the region defining the finger insertion groove 330 in the extension direction D1 and may generate an attractive force with the first magnetic member. A process of inserting the finger 100 into the finger insertion groove 330 may be smoothly performed through the first magnetic member and the second magnetic member 340. However, the finger 100 may be formed of a metallic material, and the second magnetic member 340 may generate an attractive force with the finger 100 without the first magnetic member.

Hereinafter, an operation of the present disclosure will be described in detail with reference to the drawings. First, a case in which the finger 100 and the gripper 200 are manually coupled to each other without using the station 300 will be described in detail, and then a case in which the finger 100 and the gripper 200 are coupled to each other using the station 300 will be described in detail. A separation process may be understood as a reverse process of a coupling process.

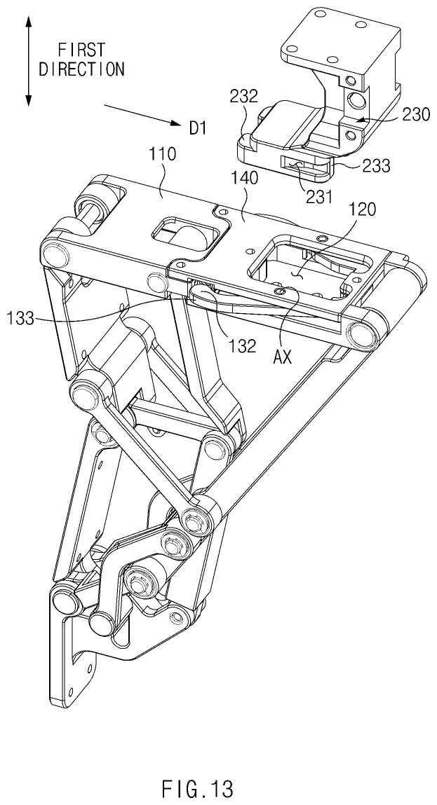

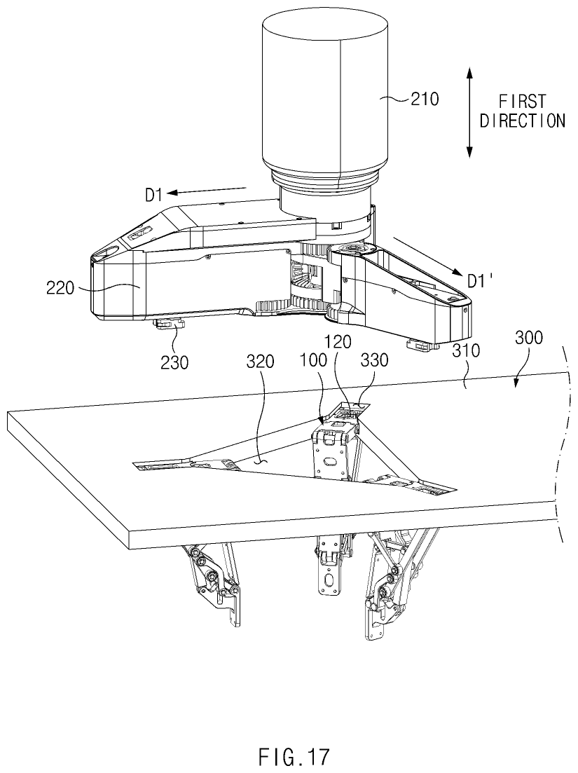

For reference, only the connecting member 230 of the gripper 200 and the finger 100 are illustrated in the drawings for ease of understanding. FIGS. 13 to 16 are views illustrating the process in which the finger and the gripper are manually coupled to each other without using the station. FIGS. 17 to 20 are views illustrating the process in which the finger and the gripper are coupled to each other using the station.

### <Manual Coupling>

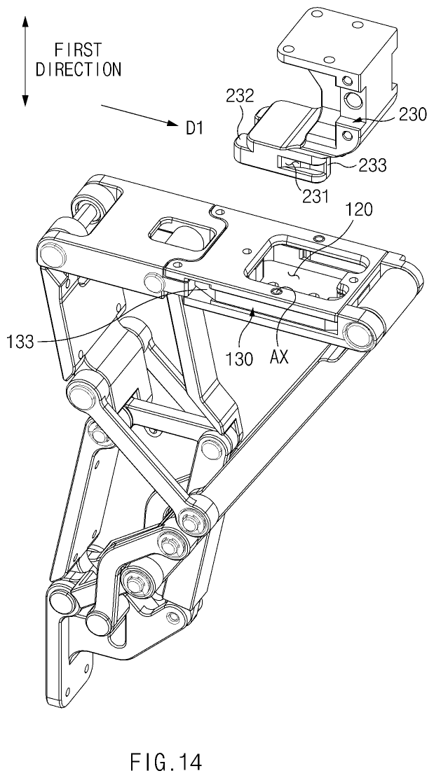

First, the protruding region 132 is pressed toward the inside of the finger body 110. In this process, the overlap between the overlapping region 131 and the mounting hole 120 disappears, and the connecting member 230 is in a state capable of being inserted into the mounting hole 120. This may be understood as a process of transition from the state of FIG. 13 to the state of FIG. 14.

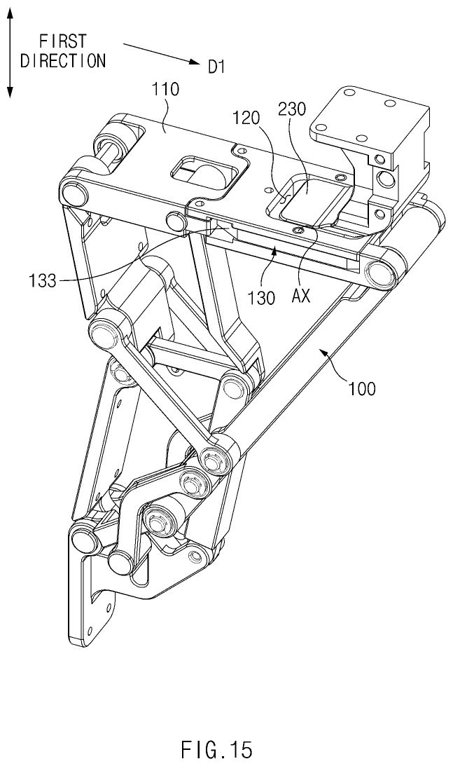

Next, the connecting member 230 is inserted into the mounting hole 120. This may be a process of moving the finger 100 upward. Alternatively, this may be a process in which the connecting member 230 is moved downward. In this process, the connecting member 230 may be separated from the mounting hole 120 upward and may be movable in the direction opposite to the extension direction D1. This may be understood as a process of transition from the state of FIG. 14 to the state of FIG. 15.

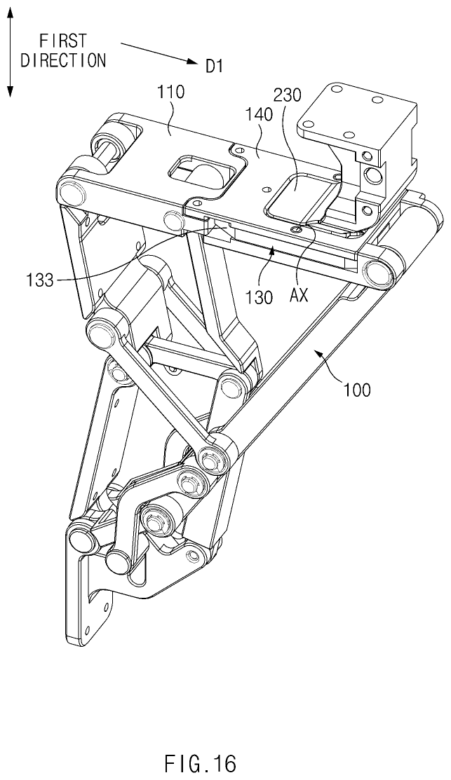

Then, the finger 100 is moved in the extension direction D1, and the press against the protruding region 132 is released. This may be a process of transition from the state of FIG. 15 to the state of FIG. 10 via the state of FIG. 16. In this process, the first overlapping portion 131a of the connecting member 230 may support the support surface 233 and may obstruct movement of the connecting member 230 in the extension direction D1 and the direction opposite to the extension direction D1. In addition, the second overlapping portion 131b may be inserted into the coupling groove 231 and may obstruct movement of the connecting member 230 in the first direction.

To manually separate the finger 100 from the gripper 200, the finger 100 and the connecting member 230 may be separated by pressing the protruding region 132 in the opposite direction, moving the finger 100 in the direction opposite to the extension direction D1, and thereafter moving the finger 100 downward.

### <Coupling Using Station 300>

The finger 100 may be mounted in the coupling groove 231 of the station 300. At this time, the protruding region 132 may be pressed toward the inside of the finger body 110 by the region of the station 300 that defines the coupling groove 231. Accordingly, the mounting hole 120 may be completely opened. This may be the state of FIG. 17.

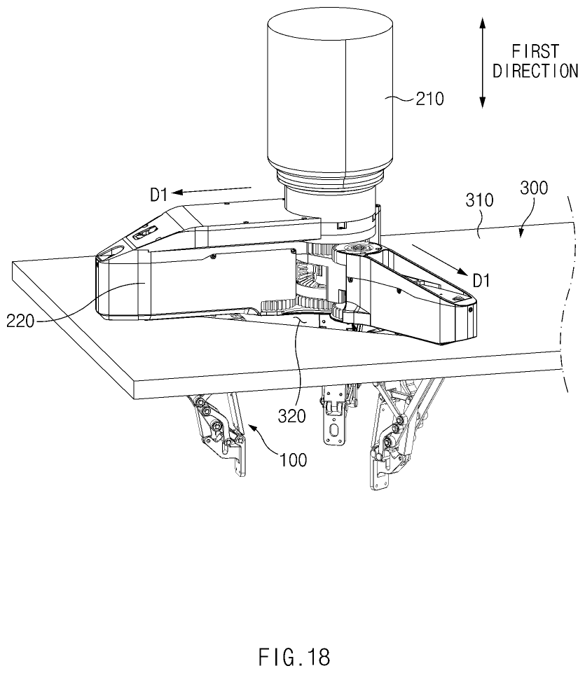

Next, the gripper 200 is located on the upper side of the finger 100. This may be a step of inserting the connecting member 230 into the mounting hole 120 of the finger 100 by moving the connecting member 230 downward. This may be the state of FIG. 18.

Then, the connecting member 230 is moved in the direction opposite to the extension direction. At this time, the finger 100 is moved in the direction opposite to the extension direction D1 by the connecting member 230. Furthermore, as the protrusion 232 of the connecting member 230 is moved in the direction opposite to the extension direction D1 and accommodated in the receiving region 121, movement of the protrusion 232 in the extension direction D1 may be allowed, but movement of the protrusion 232 in the first direction may be obstructed.

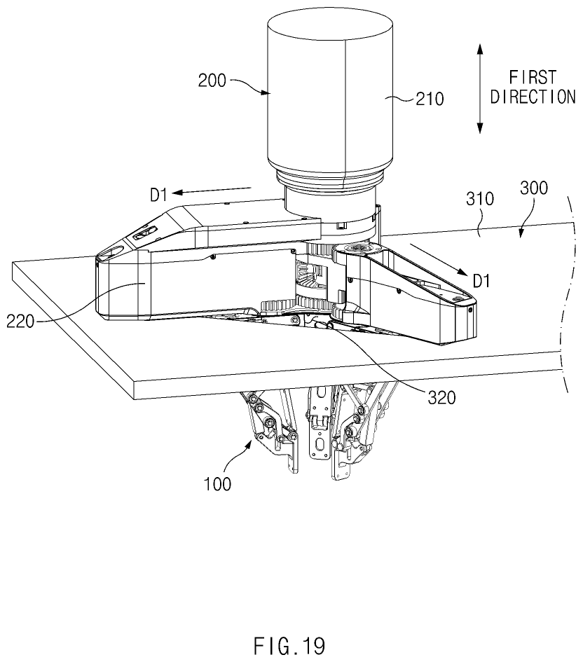

After that, the finger 100 is separated from the finger insertion groove 330 when the connecting member 230 is moved in the direction opposite to the extension direction D1. In this process, the press against the protruding region 132 disappears, and the protruding region 132 is moved outside the finger body 110 by the support member 150. In this process, the first overlapping portion 131a of the connecting member 230 may support the support surface 233 and may obstruct movement of the connecting member 230 in the extension direction D1 and the direction opposite to the extension direction D1. In addition, the second overlapping portion 131b may be inserted into the coupling groove 231 and may obstruct movement of the connecting member 230 in the first direction. This may be the state of FIG. 19.

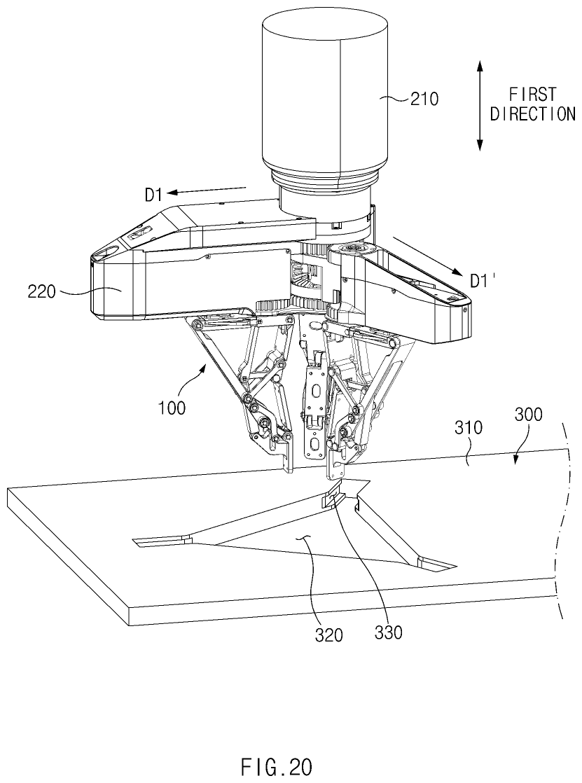

Finally, the gripper 200 is moved upward and spaced apart from the station 300. This may be the state of FIG. 20.

To separate the finger 100 and the gripper 200 through the station 300, the finger-gripper assembly is moved from the state of FIG. 20 to the state of FIG. 18 via the state of FIG. 19. In this process, the protruding region 132 may be pressed toward the inside of the finger body 110 by the region of the station 300 that defines the coupling groove 231, and the connecting member 230 may be separated from the mounting hole 120.

According to the present disclosure, depending on a purpose, only the finger may be replaced instead of replacement of the gripper and the finger assembly coupled thereto. Accordingly, the apparatus may be simplified, and a storage space for the apparatus may be reduced.

In addition, according to the present disclosure, various fingers may be replaced and used. Accordingly, the range and effect of gripping-based work may be maximized.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A finger-gripper assembly comprising:
a finger; and
a gripper to which the finger is coupled so as to be removable,
wherein the gripper comprises:
an arm;
an extender coupled to a lower end of the arm so as to be rotatable about a first axis, wherein the extender extends, from the arm, along a second axis that extends in an extension direction and intersects with the first axis; and
a connector coupled to a lower side of the extender so as to be movable along the second axis, wherein the connector is connectable to the finger.

2. The finger-gripper assembly of claim 1, wherein the finger comprises:
a finger body having a mounting hole, wherein the mounting hole is formed on an upper side of the finger body and open upward such that a lower side of the connector is inserted into the mounting hole; and
a latch connected with the connector to obstruct separation of the connector from the mounting hole, after the connector is inserted into the mounting hole.

3. The finger-gripper assembly of claim 2, wherein the latch comprises:
an overlapping region configured to overlap the mounting hole when viewed from above; and
a protrusion configured to protrude out of the finger body when viewed from above.

4. The finger-gripper assembly of claim 3, wherein the latch is rotatable about a rotational axis located between the overlapping region and the protrusion and extending in a direction of the first axis, after the protrusion is pressed toward the finger body.

5. The finger-gripper assembly of claim 4, wherein the finger further comprises a cover, in which a portion of the mounting hole is formed, the cover being coupled with the finger body and disposed on an upper side of the latch, and
wherein the latch is covered from an upper side by the cover after the protrusion is pressed toward the finger body.

6. The finger-gripper assembly of claim 3, wherein the connector comprises a coupling groove, into which the overlapping region is inserted, and
wherein movement of the connector in the direction of the first axis is restricted after the overlapping region is inserted into the coupling groove.

7. The finger-gripper assembly of claim 6, wherein the finger further comprises a support configured to elastically push the protrusion away from the finger body.

8. The finger-gripper assembly of claim 7, wherein the latch comprises a pair of latch arms spaced apart from each other with the mounting hole therebetween, and
wherein the support is disposed between protrusions of the pair of latch arms.

9. The finger-gripper assembly of claim 7, wherein the finger further comprises a stop that is brought into contact with an end portion of the overlapping region to obstruct movement of the overlapping region toward the finger body.

10. The finger-gripper assembly of claim 7, wherein the finger further comprises a cover, in which a portion of the mounting hole is formed, the cover being coupled with the finger body and disposed on an upper side of the support.

11. The finger-gripper assembly of claim 3, wherein the protrusion comprises an inclined portion in which the latch curves toward the finger body.

12. The finger-gripper assembly of claim 6, wherein the overlapping region comprises:
a first overlapping portion disposed on a side of the connector in the extension direction to support a support surface located on the side of the connector in the extension direction; and
a second overlapping portion inserted into the coupling groove to obstruct movement of the connector in the direction of the first axis.

13. The finger-gripper assembly of claim 1, wherein the extender comprises a plurality of extenders, and the finger comprises a plurality of fingers, and
wherein a quantity of the connector corresponds to a quantity of the plurality of extenders, and a quantity of the plurality of fingers corresponds e quantity of the plurality of extenders.

14. A finger-gripper assembly system comprising:
a finger;
a gripper to which the finger is coupled so as to be removable; and
a station configured to store a removed finger,
wherein the gripper comprises:
an extender configured to extend in an extension direction intersecting a first axis; and
a connector coupled to a lower side of the extender so as to be movable in the extension direction, wherein the connector is coupled to the finger,
wherein the station comprises:
a station body having a main hole; and
a finger insertion groove into which an upper side of the finger is inserted, wherein the finger insertion groove extends from the main hole in the extension direction.

15. The finger-gripper assembly system of claim 14, wherein the finger comprises:
a finger body having a mounting hole, wherein the mounting hole is formed on an upper side of the finger body and open upward such that a lower side of the connector is inserted into the mounting hole; and
a latch connected with the connector to obstruct separation of the connector from the mounting hole, after the connector is inserted into the mounting hole,
wherein a width of the finger insertion groove corresponds to a width of a portion of the finger body inserted into the finger insertion groove.

16. The finger-gripper assembly system of claim 15, wherein the latch comprises a protrusion configured to protrude out of the finger body, and
wherein the protrusion is pressed toward the finger body by a region comprising the finger insertion groove, after the finger is inserted into the finger insertion groove.

17. The finger-gripper assembly system of claim 15, wherein the finger insertion groove has an opening toward the finger body, when the finger is disposed in the finger insertion groove.

18. The finger-gripper assembly system of claim 15, wherein the finger further comprises a first magnet disposed on an end portion of the finger body in the extension direction, and
wherein the station further comprises a second magnet configured to generate an attractive force with respect to the first magnet, and wherein the second magnet is disposed, in the extension direction, on an end portion of a region comprising the finger insertion groove.

19. The finger-gripper assembly system of claim 14, wherein the extender comprises a plurality of extenders, the connector comprises a plurality of connectors, the finger comprises a plurality of fingers, and the finger insertion groove comprises a plurality of finger insertion grooves, and
wherein a quantity of the plurality of extenders corresponds to a quantity of the plurality of fingers, a quantity of the plurality of connectors corresponds to the quantity of the plurality of fingers, and a quantity of the plurality of finger insertion grooves corresponds to the quantity of the plurality of fingers.
